(19) United States
(12) Patent Application Publication
(10) Pub. No.: US 2023/0182996 A1
(43) Pub. Date: Jun. 15, 2023

(54) Storage Tank, Transport System Therewith and Method for Operating It

(71) Applicant: FMC Kongsberg Subsea AS, Kongsberg (NO)

(72) Inventors: Brede Thorkildsen, Solbergelva (NO); Mattias Rudh, Asker (NO); Renny Kunkel, Fredrikssund (DK); Sylvain Routeau, Saint Cloud (FR)

(21) Appl. No.: 17/924,648

(22) PCT Filed: May 11, 2021
(86) PCT No.: PCT/EP2021/062543

§ 371 Date: Nov. 10, 2022

(30) Foreign Application Priority Data
May 11, 2020 (NO) 20200556

(51) Int. Cl. B65D 88/78; B65D 88/02; F17C 1/00; F17C 1/16; B65D 88/54; B65D 90/48; B65D 90/32

(52) U.S. Cl. CPC B65D 88/78; B65D 88/027; F17C 1/007; F17C 1/16; B65D 88/548; B65D 90/48; B65D 90/32; B63B 2027/165

(57) ABSTRACT

Storage tank comprising—an outer container (2) having a first closable opening (23), and—an inner bladder container (3) disposed within said outer container (2) and having a second closable opening (30), said outer container (2) and inner container (3) being sealed with respect to each other, said inner container (3) being adapted to be filled and or emptied with a liquid through said second closable opening (30), a space (8) between the outer container (2) and the inner container (3) being adapted to be filled with liquid through the first closable opening (23). The outer container (2) is rigid with at least one flexible portion incorporated in the rigid outer container and configured to flex so as to expand and contract to compensate volume variations caused by pressure and or temperature variations to which the storage tank (1) is subjected.

### FIELD OF THE INVENTION

The present invention relates to a storage tank and in particular a subsea storage tank. The invention further relates to a transport system comprising a cage and a plurality of storage tanks disposed within said cage. Finally, the invention also relates to a method for operating the storage tank.

### BACKGROUND OF THE INVENTION

Many subsea oil and gas installations or assemblies require the use of liquid and in particular of chemical liquids. Such liquids may be supplied through various means. For instance, it is known the use of storage tanks within which is contained a chemical liquid and which is configured to be connected to subsea installations through umbilical tubes from a host platform or from shore.

In this context, WO 2016 179371 discloses a storage tank including a rigid outer container and a flexible inner container disposed within said outer container. The inner container is configured to be filled with a chemical liquid, hereafter also called chemical, and the space between the inner container and the outer container is configured to be filled with a barrier fluid.

During storage, transport and operation, the storage tank is subject to temperature and pressure variations causing volume variations whether it is underwater or onshore. The volume variations need to be compensated for in order to avoid the deterioration of the storage tank.

One example of a tank with an additional system is described in WO 2016/179371 where it is described a liquid storage tank comprising an outer container wherein the outer container is rigid and has at least one inner container disposed within the outer container. The at least one inner container is flexible and pressure balances while the volume of the outer container remains fixed, and the volume of the at least one inner container is variable. Disposed on the outer container is a balance assembly containing an isolation valve, a check valve and a flexible bladder. The balance assembly allows for the hydrostatic pressure to be maintained during chemical dosing and tank raising operations.

One disadvantage of such a storage tank is that it requires the use of an additional member, namely the balance assembly.

The invention seeks to provide a storage tank having a simple structure and able to comply with the volume variations caused by the pressure and temperature variations when it is onshore and underwater.

### SUMMARY OF THE INVENTION

The invention concerns a storage tank comprising:
an outer container having a first closable opening, and
an inner bladder container disposed within said outer container and having a second closable opening,
said outer container and inner container being sealed with respect to each other, said inner container being adapted to be filled and/or emptied with a liquid through said second closable opening of the storage tank, a space between the outer container and the inner container being adapted to be filled with liquid through said first closable opening of the storage tank.

According to the invention, the outer container is rigid with at least one portion configured to flex so as to expand and contract to compensate volume variations caused by pressure and/or temperature variations to which the storage tank is subjected.

Said otherwise, the outer container is rigid with at least one flexible portion incorporated in the rigid outer container and configured to flex so as to expand and contract to compensate volume variations caused by pressure and/or temperature variations to which the storage tank is subjected.

Yet in other words, the outer container comprises at least one flexible portion, or the at least one flexible portion is formed with the rigid outer container.

In yet other words, the at least one flexible portion of the outer container forms part of a wall of the outer container, i.e. it is not a separate member connected to the outer container.

The at least one flexible portion of the outer container is adapted to flex and thus compensate the variations that may occur in the storage tank. Since the at least one flexible portion is part of the rigid outer container, there is no need to use an additional separate system or member to compensate for the variations in the storage tank.

The storage tank configured in this way is thus able to comply with pressure and temperature variations during storage, installation and operation, whether it is onshore or underwater.

According to one embodiment, said at least one portion is linked to the rest of the outer container by a smooth transition. The smooth transition is a rounded or chamfered transition between two surfaces of the outer container.

This construction of the outer container provides more flexibility since sharp angles are avoided.

According to one embodiment, the outer container comprises a closed body having a transversal polygonal cross-section, said at least one portion being formed by at least one side and/or end wall of said body.

According to one embodiment, said body of the outer container presents a substantially rectangular transversal cross-section.

According to one embodiment, the outer container comprises a closed cylindrical body having a circular transversal cross-section, said at least one portion being formed by at least one end wall of said body.

According to one embodiment, the outer container is made of a polymer material such as a fibre composite, for example GRP, or a homogenous material, for example ABS.

The outer container presents thus a lower weight compared with a similar tank made of a metallic material, which provides the following benefits: transport and lifting with vehicles, vessels and cranes with lower capacity, using subsea installation vessels with lower installation crane capacity, smaller and lighter subsea template due to the lower weight in water.

Moreover, a light and strong material has an added advantage submerged as the water buoyancy reduces the specific weight.

According to one embodiment, the inner container is made of elastomer.

Elastomer presents interesting mechanical properties, in particular for hyperelasticity, stiffness and capacity to absorb impacts.

According to one embodiment, the storage tank further comprises for emptying and filling the inner container a hollow rigid member connected to the second closable opening and extending inside the inner container, preferably through the middle of the inner container.

The hollow rigid member, further the fact that it enables emptying and filling the inner container, ensures the inner container remains extended during all modes of emptying and filling.

According to one embodiment, the hollow rigid member comprises a rod and an end body at the distal end to said second opening, said end body having rounded side walls projecting on either side of said rod.

The rounded side walls protects the inner container from damage since the inner container will press on said rounded side walls when pressure is applied on the inner container. This occurs for example when the inner container is emptied from the liquid inside.

According to one embodiment, said rod comprises through bores, said rounded walls of said end body surrounds a part of the rod in which the through bore are formed, and being spaced one from the other.

The rounded walls prevent thus the inner container from blocking the through bores.

According to one embodiment, the storage tank further comprises at least one channel having a plurality of apertures along its length, said at least one channel being disposed against the hollow rigid member and/or an inner face of a wall of the outer container.

The at least one channel prevents from the formation of pocket fluids when the inner container presses against the hollow rigid member or the outer container due to pressure applied on the inner container.

According to one embodiment, the storage tank further comprises monitoring means connected to the inner container and/or the outer container, and being configured to monitor the volume variations inside the storage tank.

This enables prevention of the damage of the storage tank and therefore prevention of accidents.

A second aspect of the invention concerns a transport system comprising a cage and a plurality of storage tanks presenting the previously described features. The storage tanks are disposed within said cage, said cage comprising a suspension element configured to enable the suspension of the cage to a lifting machine.

A third aspect of the invention concerns a method of operating the storage tank having the features previously described, said method comprising the following steps:
at a topside facility, filling the inner container with a liquid and filling the space between the inner container and the outer container of the tank with a liquid;
closing the closable openings of the inner container and outer container;
transporting the storage tank to a subsea location with the closed closable openings;
at the subsea location, connecting the second closeable opening of the inner container to a subsea installation and opening the first closable opening of the storage tank to the surrounding seawater;
emptying liquid from the inner container and allowing seawater into the space between the outer container and the inner container to compensate for volume change of the inner container;
disconnecting the inner container from the subsea installation and closing the first and second closable openings before the storage tank is lifted from the subsea location and transported back to a topside facility for refilling.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a perspective view of a storage tank according to an embodiment of the invention;

FIG. 2 is a longitudinal section view of the storage tank of FIG. 1;

FIG. 3 is a longitudinal section of an outer container of the storage tank;

FIG. 4 is a perspective view of an inner container of the storage tank;

FIG. 5 is a perspective view of a hollow rigid member of the storage tank;

FIGS. 6 and 7 are detail views of an end body of the hollow rigid member of FIG. 5;

FIG. 8 is a perspective view of fluid communication channels of the outer container;

FIG. 9 is a perspective view of a transport system of the storage tank;

FIG. 10 is a longitudinal view of the transport system of FIG. 9;

FIGS. 11 to 15 are schematic views of the storage tank according to another embodiment of the invention and subject to pressure variations or impact.

### DETAILED DESCRIPTION OF THE INVENTION

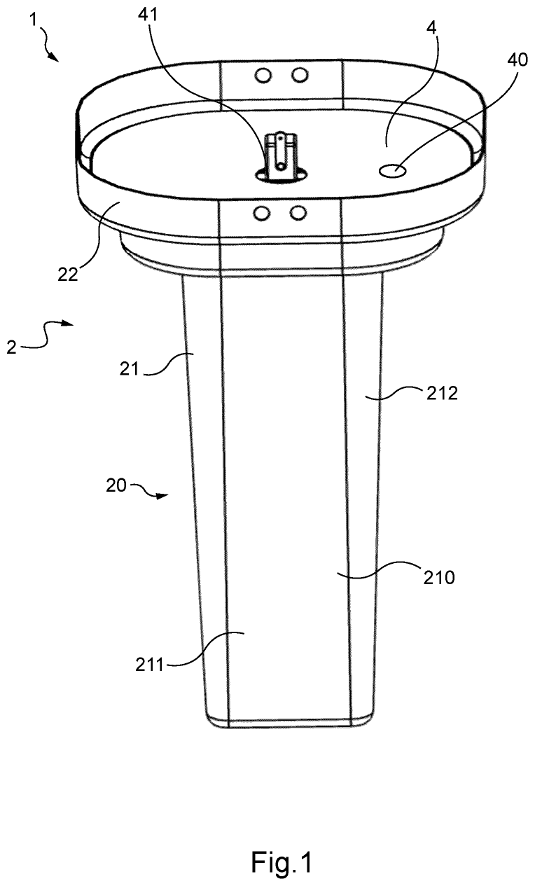

FIG. 1 is a perspective view of a subsea storage tank 1 according to one embodiment of the invention.

The storage tank 1 is adapted to store a liquid, in particular a chemical liquid, useful to operate subsea oil and gas installations. The liquid may be for example: Methanol (MeOH), Ethylene glycol (MEG) or a Scale inhibitor.

The storage tank 1 comprises an outer container 2 and an inner container 3 disposed within the outer container 2.

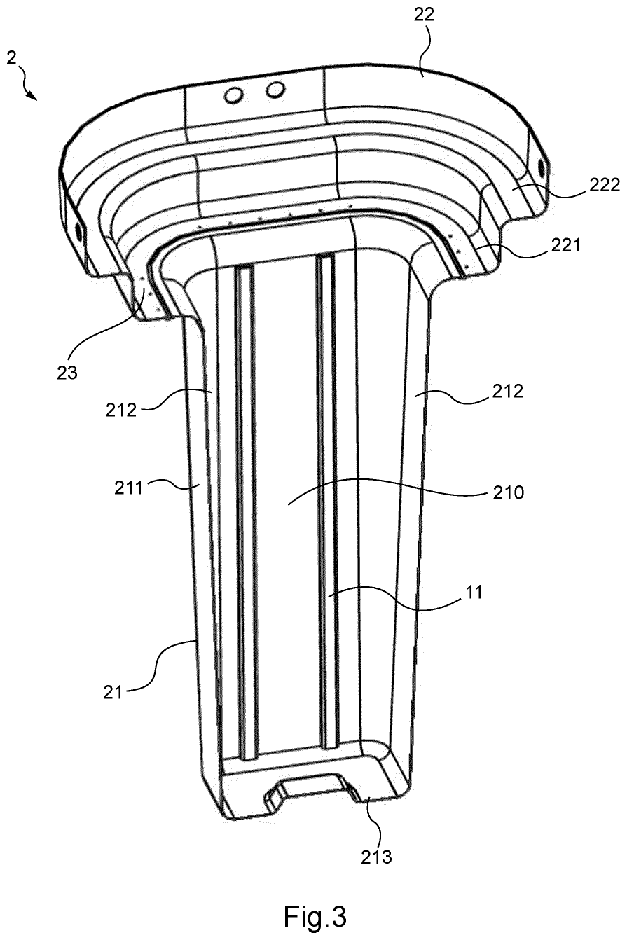

The outer container 2 (visible on FIGS. 1 to 3) comprises a body 20 defining an inner volume. The body 20 of the outer container 2 in the illustrated embodiment comprises a plurality of elements. The body 20 comprises a base 21 surmounted by a neck 22 defining a first closable opening 23 or first opening. The first opening 23 enables the connection of a valve to the outer container 2 as explained later in this document. The base 21 comprises side walls 210 and a bottom wall 213.

The outer container 2 has here a substantially parallelepiped shape with a square bottom. In particular, the outer container 2 has a substantially square transversal cross-section and a substantially trapezoidal longitudinal section.

The outer container 2 is designed with a substantially parallelepiped shape which makes the tank able to absorb changes to the liquid volume inside the storage tank 1 when the storage tank 1 is sealed off. Liquid volume change is caused by thermal expansion/contraction or due to pressure change (bulk modulus).

The substantially parallelepiped shape allows for much larger volume changes than possible with a spherical, cylindrical or conical shape. These shapes are limited by hoop stress and buckling whereas the substantially parallelepiped shape, and more generally the polygonal shape, enable considerably more flexibility.

The neck 22 of the body 20 has on an inside periphery 220 two shoulders, namely a lower shoulder 221 and an upper shoulder 222, to be created. The neck 22 presents here a larger transversal cross-section than the surface of the bottom wall 213.

The outer container 2 is rigid. The outer container 2 comprises at least one portion configured to flex so as to expand and contract. In other words, the at least one portion is designed to be flexible and have a predetermined stiffness. Preferably, the outer container 2 is configured to allow +/−5% volume variations for a GRP based outer container. The allowable volume variations can also be larger.

The flexibility of the at least one portion can be provided by different means.

For example, the flexibility can be provided by the thickness of said at least one portion. In particular, said at least one portion can be thinner than the rest of the outer container 2.

It is also possible to define and adapt the fiber orientation of the material of the at least one portion, in order to obtain the desired flexibility.

In another non-limiting example, the flexibility is achieved by designing the at least one portion so as to have smooth transitions at the connections with the rest of the outer container 2. In particular, the at least one portion has rounded or chamfered transition at which it is linked to the rest of the outer container 2.

The at least one portion of the outer container 2 can be for example constituted of a side wall of the base 21 or of a part of a wall.

As illustrated on the figures, each side wall 210 comprises a flat portion 211 and a rounded portion 212 linking adjacent walls. The at least one portion is thus constituted of the flat parts of the side walls 210. The smooth transitions between the side walls 210 formed by the rounded portions 212, confer flexibility to the side walls 210 and in particular to the at least one portion.

These examples should not be understood in a limiting manner. Moreover, they can be elected individually or combined.

The outer container 2 can be manufactured by moulding. The outer container 2 is preferably made of a light and strong material.

Preferably, the outer container 2 is made of a polymer material such as a fibre composite for example GRP, or a homogenous material, for example ABS.

The outer container 2 can present another shape. The outer container 2 can comprise another number of rounded portions 212, in particular only one rounded portion 212.

The outer container 2 can have for example any polygonal cross-section.

The outer container 2 can also have an ovoid shape. For instance, a rigid edge can surround a flexible wall of said ovoid.

The outer container 2 can also have a spherical, cylindrical or conical shape with at least one end wall being flexible. In other words, said at least one end wall forms the at least one portion.

The storage tank 1 further comprises a first lid 4 adapted to cover the outer container 2 and thus the first closable opening 23. The first lid 4 rests on the upper shoulder 222 of the neck 22 of the body 20. The first lid 4 presents here a flat shape.

The first lid 4 comprises a hole 40 enabling the communication with the first closable opening 23.

The first lid 4 also comprises another opening, or central hole 41, formed at the center of the first lid 4 and which enables the connection of a valve to the inner container 3 as explained later in this document.

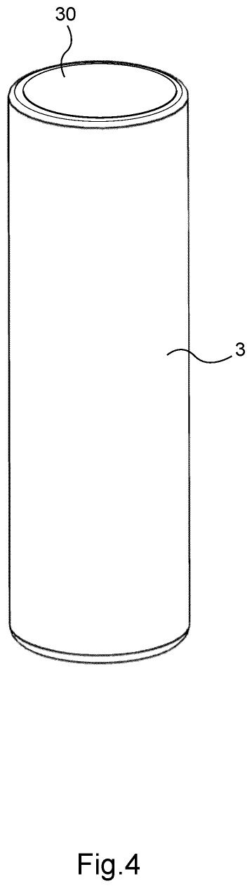

The inner container 3 (represented individually on FIG. 4), also referred to as inner bladder container, presents here a cylindrical shape with one top wall missing so as to form a second closable opening 30 or second opening. The central hole 41 of the first lid 4 here communicates with the second closable opening.

The inner container 3 is configured to be expandable and compressible. It should be noticed that the representation of the inner container 3 in the figures is only schematic. The inner container 3 is flexible (bag or bladder like) and it should not be assumed from the figures that it is rigid.

The inner container 3 can be for example made of a polymer material, such as elastomer. Preferably, the material of the inner container 3 is light and strong.

The inner container 3 is adapted to be filled with a liquid, in particular with the chemical liquid. The inner container 3 is designed as an easy replaceable item when the storage tank 1 is being serviced and filled.

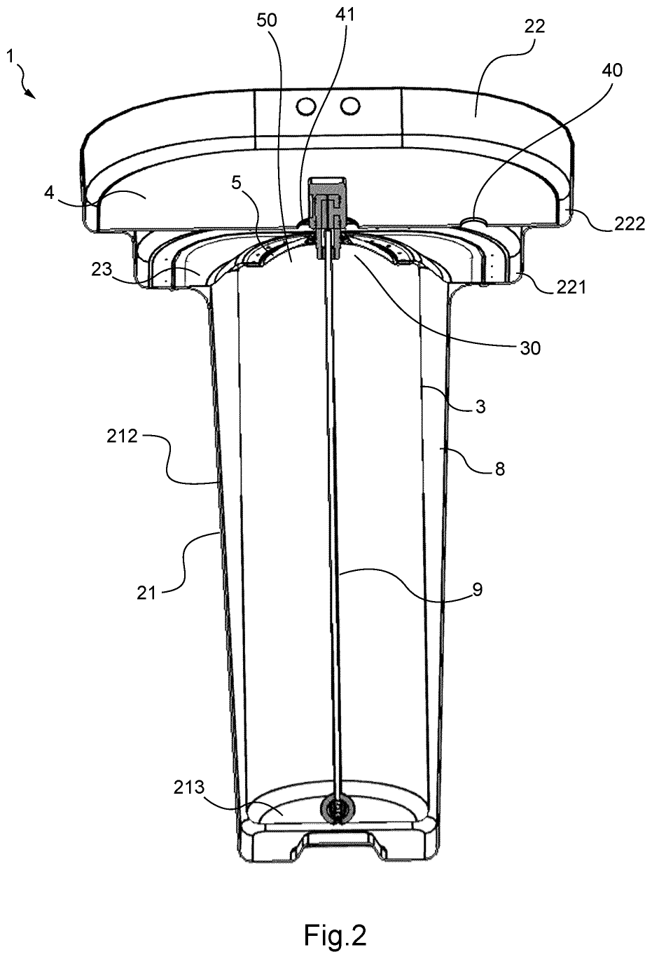

The storage tank 1 further comprises a second lid 5 (visible on FIG. 2) adapted to cover the inner container 3 and thus the second closable opening 30. The second lid 5 rests on the lower shoulder 221 of the neck 22 of the body 20. The second lid 5 presents here a concave shape. The second lid 5 also comprises a hole 50 enabling the communication with the second closable opening 30.

A space 8 (visible on FIGS. 2 and 11 to 15) between the outer container 2 and the inner container 3 is adapted to be filled with a liquid, for example with sea water. The space 8 is filled for example through the first opening 23.

The first opening 23 and the second opening 30 are closable, and the storage tank 1 can comprise means for closing the first opening 23 and the second opening 30. The means for closing can thus be configured to enable a fluidic connection to another installation for instance.

In the represented embodiment, the storage tank 1 further comprises a first valve 6 and a second valve 7 (schematically visible on FIG. 12 for example). The first opening 23 of the outer container 2 is closable by the first lid 4 and the first valve 6. The second opening 30 of the inner container 3 is closable by the second lid 5 and the second valve 7.

The first valve 6 is connected to the inner container 3 through the second opening 30 and arranged to control the flow of the liquid to and from the inner container 3. The first valve 6 is adapted to be connected to a subsea installation for provision of a liquid such as a chemical liquid.

The second valve 7 is connected to the outer container 2 through the first opening 23 and arranged to control the flow of the liquid to and from the space 8.

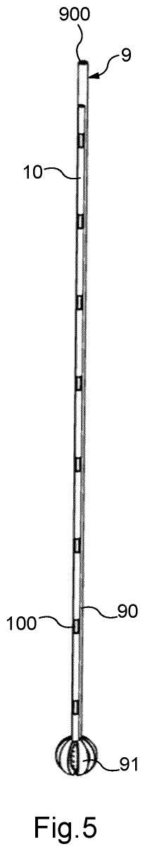

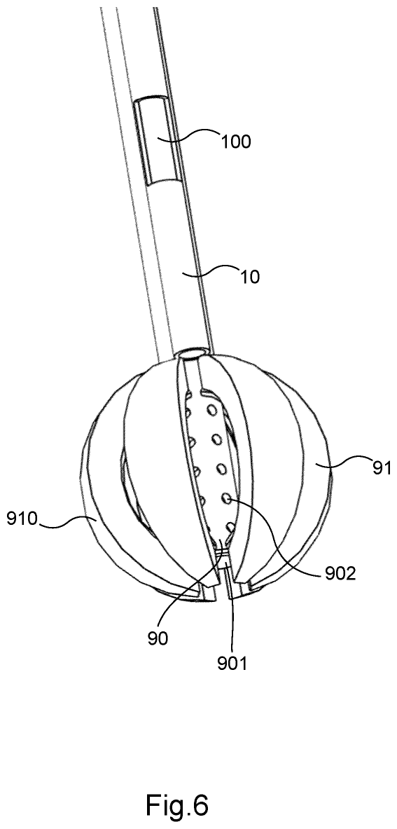

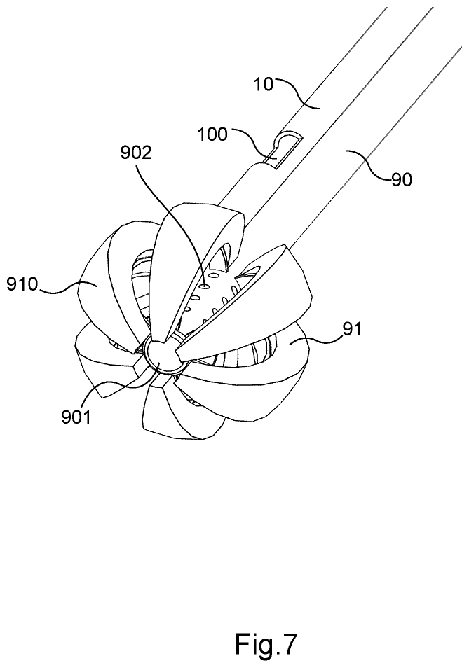

The storage tank 1 further comprises a hollow rigid member 9 (visible on FIG. 2 and represented individually on FIGS. 5 to 7). The hollow rigid member 9 extends inside the inner container 3.

In the represented embodiment, the hollow rigid member 9 extends through the middle of the inner container 3. In other words, the hollow rigid member 9 around a median longitudinal axis, or revolution axis here, of the inner container 3.

The hollow rigid member 9 comprises a rod 90 and an end body 91.

The rod 90 has a tubular shape with a first end or open end 900, and a second end 901 opposite to the open end 900. The open end 900 is connected to the central hole 41 of the first lid 4.

The rod 90 further comprises through bores 902 at an end part proximal to the second end 901. The through bores 902 are transversal bores. In the illustrated example, the rod 90 comprises four rows of five through bores 902 each. The through bores 902 enables emptying and filling the liquid inside the inner container 3.

The end body 91 extends at a distal end to the second opening. The end body 91 surrounds the end part of the rod 90, in which the through bores are formed.

In particular, the end body 91 has rounded side walls 910 projecting on either side of the rod 90. The rounded side walls 910 present the forms of slices. The rounded side walls 910 are spaced one from the other. The spaces between the rounded side walls 910 enable the passage of the liquid.

The hollow rigid member 9 enables filling and emptying the inner container 3 from the liquid.

The hollow rigid member 9 can present a different shape. The end body 91 can be for example spherical with a large aperture.

The storage tank 1 further comprises at least one fluid communication channel having a plurality of apertures along its length. The at least one channel is disposed against the hollow rigid member 9 and/or an inner face of a wall of the outer container 2.

In the described embodiment, the storage tank 1 comprises a first channel 10 extending against the hollow rigid member 9 as visible on FIGS. 5 to 7.

The first channel 10 has a tubular shape. The apertures 100 of the first channel 10 present here a rectangular shape.

Moreover, in the described embodiment, the storage tank 1 comprises two channels disposed against an inner face of each side wall of the outer container 2, i.e. eight channels also named second channels 11. Since all the second channels 11 are similar, the description is made for one second channel 11.

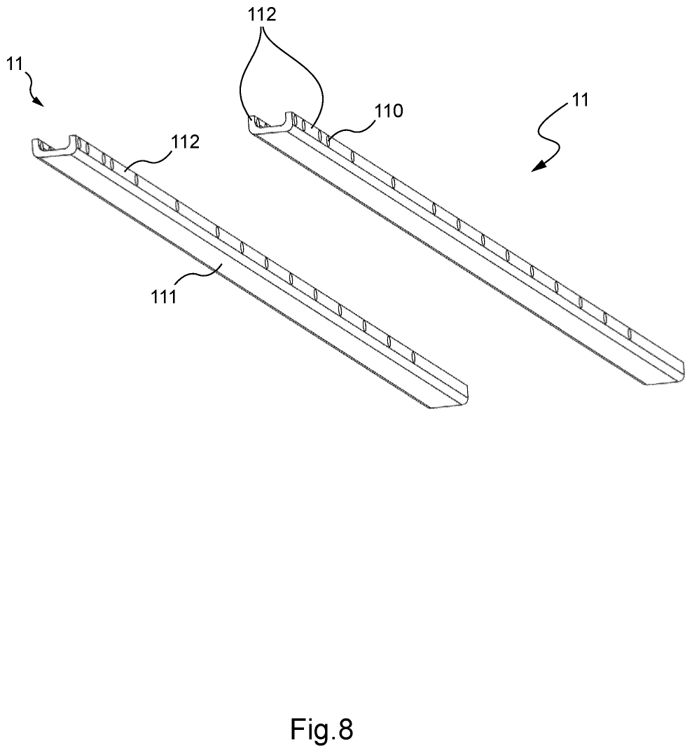

The second channel 11 (represented individually on FIG. 8) is a C-section profile, i.e. it presents a transversal cross-section in form of a C. The second channel 11 thus comprises a cross part 111 and two wings 112 extending substantially perpendicular to the cross part 111. The apertures 110 are formed along the two wings 112. The apertures 110 of the second channel 11 present a circular section.

Of course, the number and shape of first channels 10 and second channels 11 can be different.

In one embodiment not illustrated, the storage tank 1 can comprise monitoring means connected to the inner container 3 and/or the outer container 2. The monitoring means are configured to monitor the volume variations inside the storage tank 1.

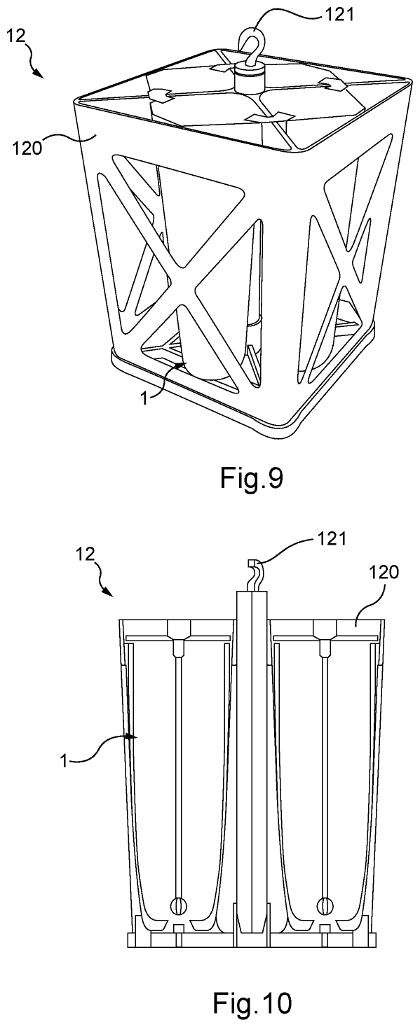

FIGS. 9 and 10 represent a transport system 12 according to an embodiment of the invention. The transport system 12 comprises a cage 120 and a plurality of storage tanks 1 such as the one described previously.

The storage tanks 1 are disposed within the cage 120. In the illustrated example, the four storage tanks 1 are disposed within the cage 120.

Preferably, the cage 120 is made of the same strong and light material as the outer container 2 to provide the same benefits, in particular with respect to easy transportation.

The cage 120 comprises a suspension element 121. The suspension element 121 is here a hook. The suspension element 121 is configured to enable the suspension of the cage 120 to a lifting machine, for example a crane, during transport of the transport system 12.

The functioning of the storage tank 1 is now described.

At a topside facility, the space 8 between the inner container 3 and the outer container 2 is first filled with a liquid, for example fresh water. It should be commented that the space 8 may be only partly filled with said liquid.

The inner container 3 is then filled with a liquid, for example a chemical liquid. This is facilitated through the hollow rigid member 9. The liquid inside the space 8 is gradually pressed out as the inner container 3 expands. Both the first and second openings are open during this mode of operation. In the illustrated example, both the first 6 and the second valves 7 are open.

The first closable opening 23 and the second closable opening 30 of the storage tank 1 are then closed once the filling of the inner container 3 is finished. The storage tank 1 can be stored before being transported to an operation location, in particular a subsea location given as an example here.

When the storage tank 1 needs to be used at the subsea location, the storage tank 1 is transported with the first closable opening 23 and second closable opening 30 closed. The storage tank 1 is then installed at the subsea location.

The flexible at least one portion of the outer container 2 configured as described previously, is able to comply with the pressure and temperature variations causing volume variations during storage, transportation and installation of the storage tank 1. The storage tank 1 remains sealed off during storage, transport and installation and only open for fluid communication during filling or when delivering the liquid.

Once the storage tank 1 needs to be used, the second closeable opening of the inner container 3 is connected to a subsea installation (not represented in the figures). Simultaneously or consecutively the first closable opening 23 is opened to the surrounding seawater.

The liquid inside the inner container 3 can thus be transferred to the subsea installation, through the hollow rigid member 9. While emptying liquid from the inner container 3, seawater is allowed to enter the space 8 between the outer container 2 and the inner container 3 through the first opening 23 to compensate for volume changes of the inner container 3.

Once the transfer of liquid needs to or can be stopped, the first and second closable openings are closed, and the inner container 3 is disconnected from the subsea installation. The first and second closable openings are thus closed before the storage tank 1 is lifted from the subsea location and transported back to a topside facility for refilling.

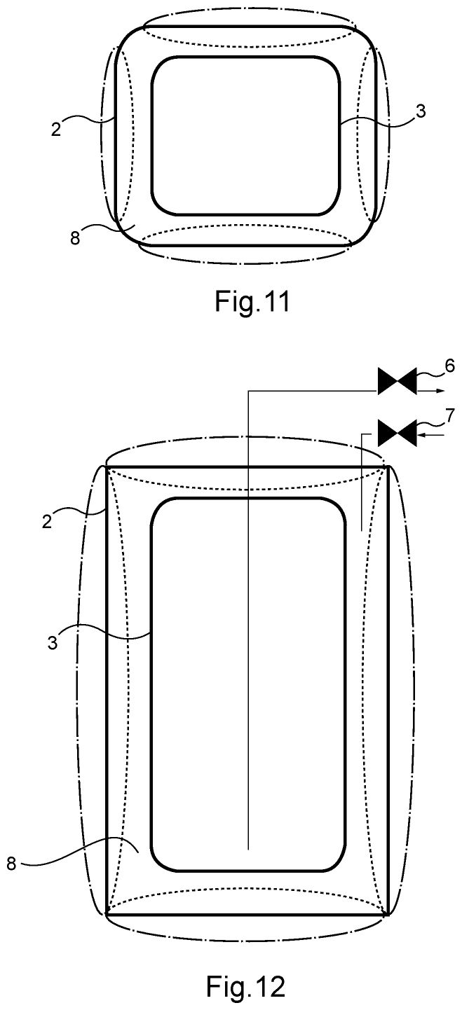

FIGS. 11 and 12 represent schematically a storage tank 1 respectively in a transversal cross-section and a longitudinal cross-section views. A plurality of elements (such as the hollow rigid member 9) are not represented. In this schematic representation, the storage tank 1 has a substantially rectangular longitudinal section.

The outer container 2 can expand or contract thus enabling both expansion or contraction of the liquid in the space 8. This occurs due to pressure or temperature variations.

Variations in external pressure transmits through the flexible at least one portion of the storage tank with a negligible small difference due to the stiffness of said flexible side. As the volume of the liquids inside is a function of the bulk modules (i.e. pressure dependent) of the liquids, the volume contracts or expand accordingly. When going from surface condition (i.e. atmospheric pressure) to subsea condition (i.e. seawater ambient pressure), the liquid volumes contracts. Vice versa when the tank is retrieved from subsea to surface, the liquid volume expands.

Similarly, variations in external temperature transmits through the sides of the tank and causes the liquids inside the tank to either expand or contract and consequently the flexible sides of the tank will expand or contracts.

There is also a secondary effect of the tank by itself expanding or contracting due to the thermal expansion coefficient of the tank material, but this is normally negligible compared to the liquid volume changes.

Temperature variations can also be caused by internal heating or cooling.

A neutral position or shape of the outer tank when there is pressure balance in the storage tank 1 and with respect to the external environment is represented with a continuous line. An expanded shape and a contracting shape of the outer tank are respectively represented in a dashed line and in a dotted line.

A parallelepiped shape is described and represented but other shapes and in particular angular or polygonal shape can be used, however with smaller or larger relative flexibility.

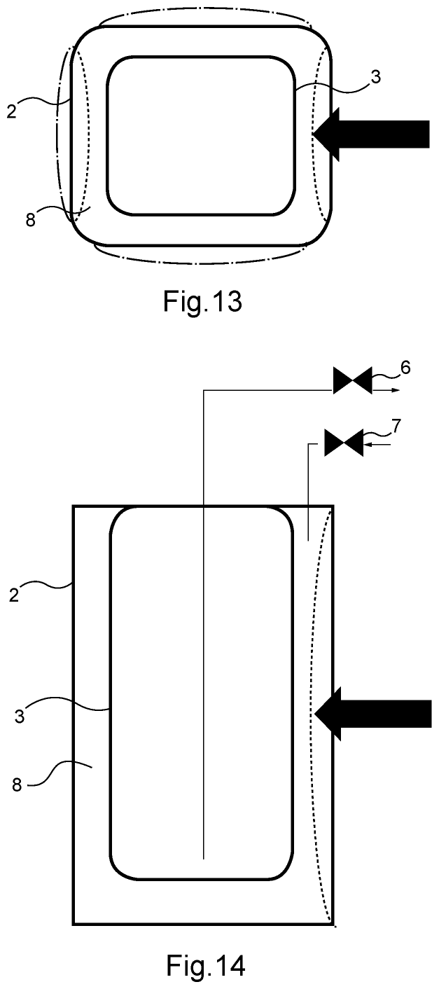

FIGS. 13 and 14 also represent schematically the storage tank 1 respectively in a transversal cross-section and a longitudinal cross-section views. These figures represent when the storage tank 1 is subject to an impact, here at a side wall of the outer container 2. The impact is represented with an arrow.

The outer container 2 as designed, and in particular thanks to the parallelepiped shape, cushions the impact by absorbing and distributing the pressure pulse. The outer container 2 can bulge inward (by the impact) and outward by the resulting pressure pulse, thus reducing the pressure increase by the impact. The pressure pulse passes through the inner container 3 without damage.

In this way, the storage tank 1, and in particular the inner container 3, is well protected against impacts.

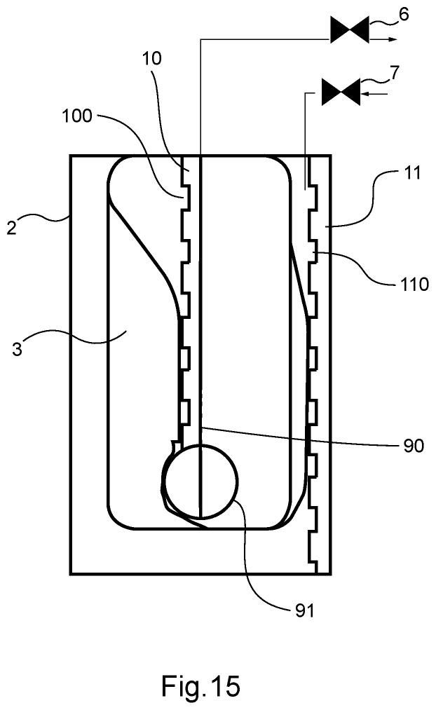

Finally, FIG. 15 represents schematically the storage tank 1 in a longitudinal cross-section view and in which the hollow rigid member 9 and two channels are represented.

Forces can act on the inner container 3, caused by difference in buoyancy, handling and when the inner container 3 is emptied. When this occurs, the inner container 3 presses against the hollow rigid member 9 and inner faces of the outer container 2 as represented on the figures. In particular in the illustrated embodiment, the inner container 3 presses against a first channel 10 and a second channel 11.

The hollow rigid member 9, having in particular rounded side walls 910, protects the inner container 3 from damage caused by the forces acting on said inner container 3. The rounded side walls 910 also protecting the inner container from potential sharp objects.

Moreover, the rounded side walls 910 of the hollow rigid member 9 prevent the bladder from blocking the through bores 902 of the rod 90 due to suction effect.

Furthermore, the first channel 10 and the second channel 11 being furnished with apertures 100, 110, this ensures that the liquid, such as chemical liquid and seawater, does not become isolated in a portion of the storage tank 1 if the inner container 3 is pressed towards the outer container 2 or the hollow rigid member 9. In other words, it prevents the formation of fluid pockets.

The second channels 11 also ensure that the liquid in the space 8, here the seawater, can freely flow in the entire space 8 and not be prevented by the inner container 3 blocking the movement.

The present invention is not limited to the described and illustrated embodiments.

Other features and embodiments are possible such as the following provided as non-limiting examples:
Remaining Liquid Measurement
   Measurement of remaining liquid in the storage tank 1 can be made by a combination of a subsea acoustic or visual measurement and machine Learning.
Sea Water Ingress
   Using conductivity as means to quantify seawater ingress, for example by mounting conductivity probes internally in the inner container 3.
   Near Infrared (NIR) measurements can be used to quantify the amount of salt water in an injection chemical stream. A small measurement chamber can be filled with the chemical liquid and then in increments replaced with known amounts of seawater in the upstream hollow rigid member. This would provide an in-situ calibration of the expected response when the chemical liquid is mixed with seawater.
Method of operation/life cycle
   Filling and filtering the liquid inside the inner container 3 to correct cleanliness in a controlled environment. This ensures that the chemical that arrives at the injection point is the correct chemical with correct cleanliness.

The description is mainly related to subsea but of course, other applications involving the technical problem of complying with volume variations due to temperature and/or pressure variations in a storage tank are possible. Examples of other applications: Inside fluid storage tanks on vessels (e.g. crude oil), inside fluid storage caverns (e.g. gas), inside water treatment plants.

1. A storage tank comprising
an outer container having a first closable opening; and
an inner container disposed within said outer container and having a second closable opening;
wherein said outer container and inner container are sealed with respect to each other, wherein said inner container is adapted to be filled and/or emptied with a liquid through said second closable opening, and wherein a space between the outer container and the inner container is adapted to be filled with liquid through the first closable opening; and
wherein the outer container is rigid and comprises at least one flexible portion configured to flex so as to expand and contract to compensate volume variations caused by pressure and/or temperature variations to which the storage tank is subjected.

2. The storage tank according to claim 1, wherein said at least one flexible portion comprises a first surface which is linked to an adjacent surface of the outer container by a smooth rounded or chamfered transition portion of the outer container.

3. The storage tank according to claim 1, wherein the outer container comprises a closed body having a transversal polygonal cross-section, said at least one flexible portion being formed by at least one side wall and/or end wall of said body.

4. The storage tank according to claim 3, wherein said body of the outer container comprises a substantially rectangular transversal cross-section.

5. The storage tank according to claim 1, wherein the outer container comprises a closed cylindrical body having a circular transversal cross-section, said at least one flexible portion being formed by at least one end wall of said body.

6. The storage tank according to claim 1, wherein the outer container is made of a polymer material or a homogenous material.

7. The storage tank according to claim 1, wherein the inner container is made of an elastomer.

8. The storage tank according to claim 1, further comprising a hollow rigid member connected to the second closable opening and extending inside the inner container, the hollow rigid member being configured for use in emptying and filling the inner container.

9. The storage tank according to claim 8, wherein said hollow rigid member comprises a rod and an end body at a distal end relative to said second closable opening, said end body having rounded side walls projecting on either side of said rod.

10. The storage tank according to claim 9, wherein said rod comprises through bores, wherein said rounded walls of said end body surround a part of the rod in which the through bores (902) are formed, and wherein said rounded walls are spaced one from the other.

11. The storage tank according to claim 8, further comprising at least one channel having a plurality of apertures along its length, said at least one channel being disposed against the hollow rigid member and/or an inner face of a wall of the outer container.

12. The storage tank according to claim 1, further comprising monitoring means connected to the inner container and/or the outer container and being configured to monitor volume variations inside the storage tank.

13. A transport system comprising a cage and a plurality of storage tanks according to claim 1, said storage tanks being disposed within said cage, and said cage comprising a suspension element configured to enable the suspension of the cage from a lifting machine.

14. A method of operating the storage tank according to claim 1, said method comprising:
at a topside facility, filling the inner container with a liquid and filling the space between the inner container and the outer container with a liquid;
closing the first and second closable openings;
transporting the storage tank to a subsea location with the closable openings closed;
at the subsea location, connecting the second closeable opening of the inner container to a subsea installation and opening the first closable opening of the outer container to the surrounding seawater;
emptying liquid from the inner container and allowing seawater into the space between the outer container and the inner container to thereby compensate for volume changes of the inner container; and
disconnecting the inner container from the subsea installation and closing the first and second closable openings before the storage tank is lifted from the subsea location and transported back to a topside facility for refilling.
